(19) United States
(12) Patent Application Publication
(10) Pub. No.: US 2013/0002823 A1
(43) Pub. Date: Jan. 3, 2013

(54) IMAGE GENERATING APPARATUS AND METHOD

(75) Inventors: Hwa Sup LIM, Hwaseong-si (KR); Kee Chang Lee, Yongin-si (KR); Seung Kyu Lee, Seoul (KR)

(73) Assignee: SAMSUNG ELECTRONICS CO., LTD., Suwon-si (KR)

(21) Appl. No.: 13/446,336

(22) Filed: Apr. 13, 2012

(30) Foreign Application Priority Data
Jun. 28, 2011 (KR) 10-2011-0062598

(51) Int. Cl. H04N 15/00; H04N 5/33; H04N 13/02

(52) U.S. Cl. 348/46; 348/E15.001; 348/E05.09

(57) ABSTRACT

An image generating apparatus may include a first reflector and a second reflector. When a light emitter emits an infrared light, the infrared light may be reflected from a first reflector and be omni-directionally reflected. The reflected infrared light that is the infrared light reflected from the object may be reflected from a second reflector and be transferred to a sensor. The sensor may receive the reflected infrared light and generate a depth image of the object.

### CROSS-REFERENCE TO RELATED APPLICATIONS

This application claims the priority benefit of Korean Patent Application No. 10-2011-0062598, filed on Jun. 28, 2011, in the Korean Intellectual Property Office, the disclosure of which is incorporated herein by reference.

### BACKGROUND

1. Field

Example embodiments relate to an image generating apparatus and method, and more particularly, an apparatus and method that may generate an omni-directional three-dimensional (3D) image by acquiring omni-directional depth and color images.

2. Description of the Related Art

Currently, interest in a three-dimensional (3D) image has been increasing. In addition, interest in 3D real picture image information beyond a two-dimensional (2D) image map has been increasing. In particular, the 3D real picture image information may be provided as a service name. For example, a street view or a road view may correspond to information based on 3D panoramic real pictures. However, the 3D real picture image information may be constrained to a 2D image in which a user cannot experience a 3D effect.

Depth cameras for acquiring depth images may be classified into at least two types of depth cameras based on a corresponding operation scheme.

One is a time of flight (TOF) scheme that may emit an infrared (IR) light of which a light source is modulated, and then calculate a distance from each sensor pixel using a phase difference between the emitted IR light and a reflected IR light that is reflected from an object space and is received at a depth sensor.

Another is a structured light type scheme that may emit an IR light of which a light source is structured as patterns, and then generate a depth image using a pattern received at a depth sensor. The structured light type scheme may be sub-classified into a plurality of schemes again based on a pattern structured scheme.

### SUMMARY

Additional aspects and/or advantages will be set forth in part in the description which follows and, in part, will be apparent from the description, or may be learned by practice of the invention.

The foregoing and/or other aspects are achieved by providing an image generating apparatus including a light emitter to emit an infrared light; a reflector to reflect the infrared light and thereby transfer the reflected infrared light to an object, and to reflect the reflected infrared light that is reflected from the object; and a sensor to receive the reflected infrared light that is reflected from the reflector, and to generate a depth image of the object.

The reflector may correspond to an omni-directional mirror that simultaneously reflects, into predetermined directions, the infrared light emitted from the light emitter.

The sensor may generate the depth image using a time of flight (TOF) scheme by detecting a phase difference between the infrared light emitted from the light emitter and the reflected infrared light that is reflected from the reflector.

The sensor may further generate a color image of the object by receiving a visible light that is transferred from the object to the reflector and thereby is reflected from the reflector.

The image generating apparatus may further include a processor to match the depth image and the color image by correcting at least one of a definition and a direction with respect to at least one of the depth image and the color image generated by the sensor.

The processor may perform at least one preprocessing of noise cancellation and compensating of depth folding in the depth image before matching the depth image and the color image.

The foregoing and/or other aspects are achieved by providing an image generating apparatus including a light emitter to emit an infrared light; a first reflector to reflect the infrared light and transfer the reflected infrared light to an object; a second reflector to reflect the reflected infrared light that is reflected from the object; and a sensor to generate a depth image of the object by receiving the reflected infrared light that is reflected from the second reflector.

The first reflector may correspond to an omni-directional mirror that simultaneously reflects, into predetermined directions, the infrared light emitted from the light emitter.

The second reflector may correspond to an omni-directional mirror that reflects, towards the sensor, the reflected infrared light reflected from the object present in a predetermined direction.

The light emitter may emit the infrared light having a different pattern with respect to each of different angles.

The sensor may generate the depth image by determining a first angle between the light emitter and the object and a second angle between the sensor and the object based on a pattern of the reflected infrared light that is reflected from the second reflector, and by calculating a distance between the sensor and the object based on the first angle and the second angle.

The light emitter may emit the infrared light so that different patterns may be generated with respect to different distances.

The sensor may generate the depth image by identifying a reflected pattern corresponding to the object based on a pattern of the reflected infrared light that is reflected from the second reflector.

The sensor may correspond to a color and depth (C/D) sensor to further generate a color image of the object by receiving a visible light that is transferred from the object to the second reflector and is reflected from the second reflector.

The image generating apparatus may further include a processor to match the depth image and the color image by correcting at least one of a definition and a direction with respect to at least one of the depth image and the color image generated by the sensor.

The foregoing and/or other aspects are achieved by providing a method of generating a color image and a depth image in an image generating apparatus, the method including emitting, by a light emitter of the image generating apparatus, an infrared light; reflecting, by a first reflector of the image generating apparatus, the infrared light to transfer the reflected infrared light to an object; reflecting, by a second reflector of the image generating apparatus, a visible light and the reflected infrared light that is reflected from the object, to a sensor of the image generating apparatus; and receiving, by the sensor, the reflected infrared light to generate the depth image, and receiving the visible light to generate the color image.

The example embodiments may include an image generating apparatus and method that may be commercialized with a simple structure and a minimum production cost and may also generate an omni-directional depth image.

The example embodiments may also include an image generating apparatus and method that may minimize an image processing process including image warping and may also generate a high quality omni-directional three-dimensional (3D) image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image generating apparatus according to example embodiments;

FIG. 2 illustrates a configuration of an image generating apparatus according to example embodiments;

FIG. 3 illustrates a diagram to describe a process of emitting, by a light emitter, structured patterns and a process of generating a depth image using the structured patterns according to example embodiments;

FIG. 4 illustrates a diagram to describe a process of emitting, by a light emitter, structured patterns and a process of generating a depth image using the structured patterns according to other example embodiments;

FIG. 5 illustrates a configuration of an image generating apparatus according to other example embodiments;

FIG. 6 illustrates a diagram to describe a process of generating a depth image based on a phase difference between an infrared light emitted from a light emitter and a reflected infrared light reflected from an object according to example embodiments; and

FIG. 7 illustrates an image generating method according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

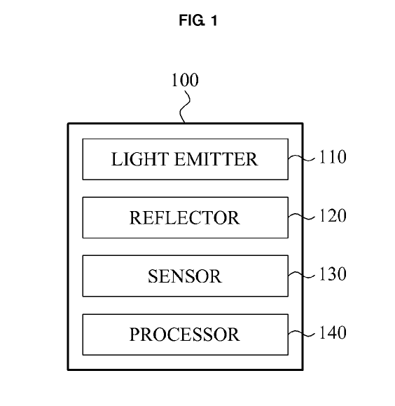

FIG. 1 illustrates an image generating apparatus 100 according to example embodiments.

Referring to FIG. 1, the image generating apparatus 100 may include a light emitter 110 to emit an infrared (IR) light, a reflector 120 to reflect the IR light and thereby transfer the reflected IR light to an object, and to reflect the reflected IR light that is reflected from the object, and a sensor 130 to receive the reflected IR light that is reflected from the reflector 120, and to generate a depth image of the object.

The light emitter 110 may have a predetermined configuration to emit an IR light for generating a depth image. For example, the light emitter 110 may be a light emitting module including an IR light emitting diode (LED) element.

The reflector 120 may correspond to an omni-directional mirror that simultaneously reflects, into predetermined directions, the IR light emitted from the light emitter 110.

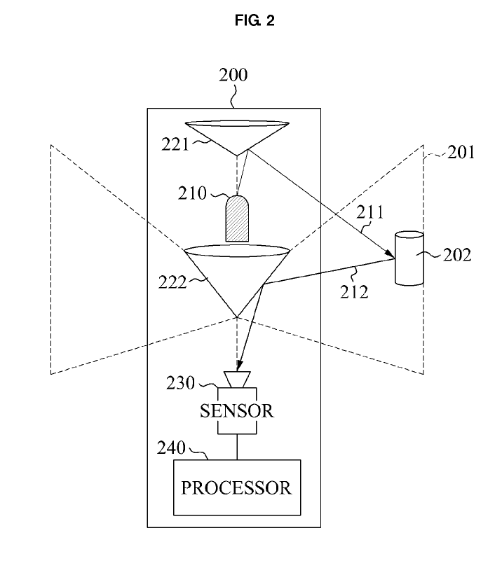

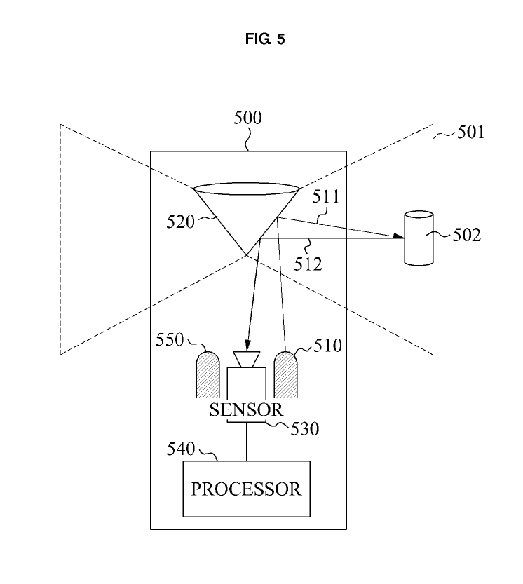

In this example, the omni-directional mirror may be a predetermined reflecting body that may reflect, towards the sensor 130, a light from a predetermined direction excluding a virtual axial direction between the sensor 130 and the reflector 120. A detailed configuration will be further described with reference to FIG. 2 and FIG. 5.

The sensor 130 may be a predetermined imaging element capable of generating a depth image using the reflected IR light that is reflected from the reflector 120. The sensor 130 may have an operation range within at least a portion of an IR wavelength band.

According to embodiments, the sensor 130 may be understood to be wider than a pixel plate that is a set of general photoelectric elements. Therefore, the sensor 130 may include photoelectric elements and also include a controller to control the photoelectric elements and an imaging processor.

The sensor 130 may generate the depth image using the reflected IR light that is reflected from the reflector 120, according to a time of flight (TOF) scheme or a structured pattern light type scheme.

Hereinafter, embodiments associated with the respective schemes will be described.

According to the TOF scheme, the sensor 130 may generate a depth image by detecting a phase shift or a phase difference between an IR light emitted from the light emitter 110 and a reflected IR light that is reflected from the reflector 120, and by calculating a distance between the object and the image generating apparatus 100.

In the embodiment of the TOF scheme, a distance between the light emitter 110 and the sensor 130 may need to be minimized to minimize a phase difference detection error.

Therefore, the reflector 120 may be a single omni-directional mirror. In this example, the light emitter 110 may emit an IR light towards the reflector 120 at a position maximally close to the sensor 130. The sensor 130 may receive the reflected IR light after the IR light is reflected from the object through the same reflector 120.

The phase difference detection error may decrease as the light emitter 110 becomes closer to a virtual axis due to a close distance between the light emitter 110 and the sensor 130. Here, the close distance between the light emitter 110 and the sensor 130 is relative. Even though the distance between the light emitter 110 and the sensor 130 is remains the same, the phase difference detection error may increase as the distance from the light emitter 110 and/or the sensor 130 to the reflector 120 decreases.

When the sensor 130 detects a phase difference according to the TOF scheme, it may be possible to compensate for the phase difference detection error based on the distance between the light emitter 110 and the sensor 130 and/or the distance between the reflector 120 and the sensor 130. However, a further detailed description may be mathematically straightforward and thus, will be omitted here.

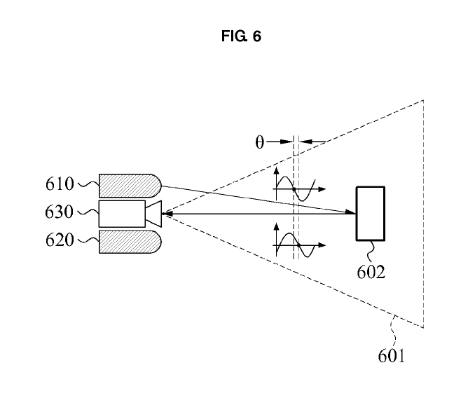

A process of generating, by the sensor 130, a depth image according to the TOF scheme will be further described with reference to FIG. 5 and FIG. 6.

According to the structured pattern light type scheme, the sensor 130 may generate a depth image using a received reflected IR light. The structured pattern light type scheme may be simply referred to as a structured light type scheme.

In the structured pattern light type scheme, the sensor 130 may generate the depth image by determining a distance between the image generating apparatus 100 and the object based on an IR pattern received at the sensor 130.

The structured pattern light type scheme may be sub-classified into a plurality of schemes again based on a pattern structured scheme. Two schemes will be herein described as examples.

In one scheme, the light emitter 110 may generate different IR patterns based on an emitting direction in which an IR light proceeds. In another scheme, the light emitter 110 may generate different IR patterns based on a distance from the light emitter 110.

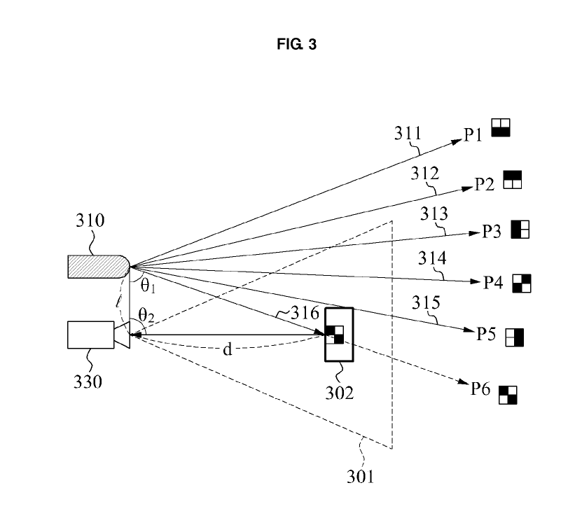

According to the first scheme, even though distances from the light emitter 110 to objects are the same, the objects positioned at relatively different positions may be exposed to different patterns of IR lights. The above pattern difference will be further described with reference to FIG. 3.

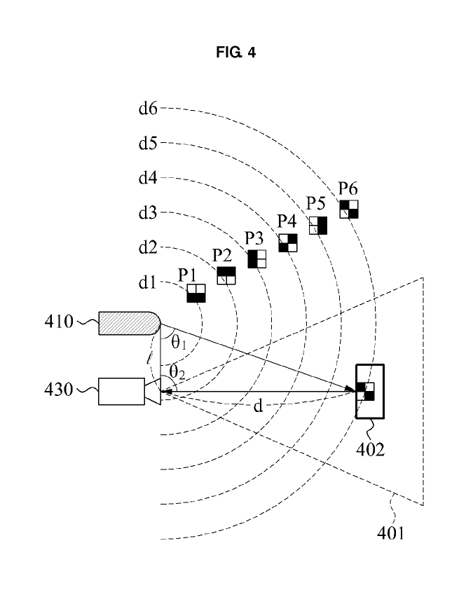

According to the second scheme, different objects linearly positioned in the same direction as the light emitter 110 may be exposed to different patterns of IR lights based on distances from the light emitter 110. The above pattern difference will be further described with reference to FIG. 4.

In the embodiment of the structured pattern light type scheme, the reflector 120 of the image generating apparatus 100 may include at least two reflectors that are structurally separable elements. The at least two reflectors may be different omni-directional mirrors.

Among the at least two reflectors, a first reflector may reflect, towards an object, an IR light that is emitted from the light emitter 110, and a second reflector may reflect again a reflected IR light that is reflected from the object and thereby transfer the reflected IR light to the sensor 130. A configuration and an operation of reflectors will be further described with reference to FIG. 2.

In the structured pattern light type scheme, a plurality of reflectors may be present since angles between the light emitter 110 and the sensor 130, and a predetermined point of an object space need to be determined using a triangulation scheme. The reflectors will be further described with reference to FIG. 2 through FIG. 4.

According to embodiments, the sensor 130 may be a color and depth sensor that may generate a depth image by receiving an IR light and may also generate a color image by receiving a visible light. The color and depth sensor may be simply referred to as a C/D sensor.

The color and depth sensor may have, within a single sensor structure, pixels having sensitivity in an IR band as well as pixels having a high sensitivity in a red, green, or blue wavelength band that is a visible light band.

According to embodiments, a pixel sensitive in the red wavelength band, a pixel sensitive in the green wavelength band, a pixel sensitive in the blue wavelength band (the pixels are referred to as color pixels), and pixels sensitive in the IR band may be uniformly mixed and thereby be arranged within the sensor 130.

According to other embodiments, color pixels may receive an IR light together whereby pixels sensitive to the IR light may be omitted or be at least reduced.

Also, a color pixel part and an IR pixel part that are structurally separable may be present together within the sensor 130. Further description related to a pixel configuration will be omitted.

The image generating apparatus 100 may further include a processor 140 to match a depth image and a color image that are generated by the sensor 130, when the depth image and the color image do not match each other in at least one aspect of a definition and a direction, that is, when the depth image and the color image are unmatched with each other. The direction may be, for example, a photographing viewpoint.

In general, the depth image generated by the sensor 130 may have a definition lower than the color image and include a significant amount of noise. That is, the depth image may have a relatively low quality compared to the color image. The direction of the color image and the direction of the depth image may not match each other. Here, the direction may be, for example, a photographing viewpoint. The above examples correspond to a case where the color image and the depth image do not match.

In this case, the processor 140 may perform resizing or perform warping such as rotation or panning, for example, by matching the color image to be fit for the depth image or by matching the depth image to be fit for the color image. This process is referred to as “matching”. Further description related to matching of the depth image and the color image will be omitted here.

The processor 140, which may be a computer, may perform at least one of preprocessing of noise cancellation or noise reduction, and compensating of depth folding in the depth image before matching the depth image and the color image.

According to embodiments, it is possible to generate a more accurate three-dimensional (3D) image using a depth image and a color image.

Hereinafter, embodiments will be further described with reference to FIG. 2 through FIG. 6.

FIG. 2 illustrates a configuration of an image generating apparatus 200 according to example embodiments.

The image generating apparatus 200 may be an example of the image generating apparatus 100 according to the structured pattern light type scheme described above with reference to FIG. 1.

The image generating apparatus 200 may include at least two reflectors, for example, a first reflector 221 and a second reflector 222 that are structurally separable elements.

The at least two reflectors may be included to decrease an error in calculating a distance, that is, a depth between the image generating apparatus 200 and an object using an IR pattern that is emitted from a light emitter 210, when the IR pattern is reflected from the object and thereby is received at a sensor 230.

The above error may decrease when a baseline between the light emitter 210 and the sensor 230 is stably fixed.

An IR light 211 emitted in a structured pattern type from the light emitter 210 may reach an object 202 within a field of view 201 through the first reflector 221.

The reflected IR light 212 that is reflected from the object 202 may be reflected again from the second reflector 222 and reach the sensor 230. A processor 240 may be an example of the processor 140 of FIG. 1 and be an imaging processor that is connected to the sensor 230 to perform image processing.

An example in which the sensor 230 generates a depth image by receiving the reflected IR light 212 of the structured pattern and by calculating a distance from the object 202 will be further described with reference to FIG. 2 and FIG. 3.

FIG. 3 illustrates a diagram to describe a process of emitting, by a light emitter 310, structured patterns and a process of generating a depth image using the structured patterns according to example embodiments.

FIG. 3 corresponds to the embodiment in which different IR patterns are generated based on an emitting direction in which an IR light proceeds, between the two embodiments of the structured pattern light type scheme.

In FIG. 3, the first reflector 221 and the second reflector 222 of FIG. 2 are not shown to help understanding of a process of identifying, by, a sensor 330, an IR pattern to calculate a distance d between the sensor 330 and an object 302. Even though a description regarding that an IR progress path may vary by the first reflector 221 and the second reflector 222 is omitted, those skilled in the art may readily understand the operational principle of the embodiments.

Referring to FIG. 3, the light emitter 310 may emit different patterns P1, P2, P3, P4, P5, and P6 of IR lights into different directions 311, 312, 313, 314, 315, and 316. Accordingly, even though distances from the light emitter 310 are the same, objects positioned at different positions may be exposed to the different patterns P1, P2, P3, P4, P5, and P6 of IR lights, respectively. The emitted IR patterns may reach the respective corresponding objects within a field of view 301 of the sensor 330.

It can be verified that the patterns P1, P2, P3, P4, P5, and P6 are different from each other based on the directions 311, 312, 313, 314, 315, and 316. The patterns P1, P2, P3, P4, P5, and P6 are only an example to help understanding and thus, an actual application may not follow the above scheme.

Among the various patterns P1, P2, P3, P4, P5, and P6 of IR lights emitted from the light emitter 310, the object 302 may be exposed to the pattern P6 progressing into the direction 316. The pattern P6 of the IR light may be reflected from the object 302 and be received at the sensor 330.

Accordingly, an angle θ2 may be determined based on the direction 316 in which the pattern P6 is received, and an angle θ1 may also be determined since a progress direction of the pattern P6 is specified.

In addition, since a distance, that is, a baseline ′l between the light emitter 310 and the sensor 330 is known, a distance d between the sensor 330 and the object 302 may be calculated using a function of the angle θ1, the angle θ2, and the distance ′l. Here, d=f (θ1, θ2, l).

A detailed calculating process belongs to a basic triangulation scheme and thus, further detailed description will be omitted here.

According to the above scheme, the sensor 330 may generate a depth image by calculating a distance from each of patterns within the field of view 301.

FIG. 4 illustrates a diagram to describe a process of emitting, by a light emitter 410, structured patterns and a process of generating a depth image using the structured patterns according to other example embodiments.

FIG. 4 corresponds to the embodiment in which the light emitter 410 generates different IR patterns based on a distance from the light emitter 410, between the two embodiments of the structured pattern light type scheme.

In FIG. 4, the light emitter 410 may emit different patterns P1, P2, P3, P4, P5, and P6 of IR lights to objects positioned at different distances d1, d2, d3, d4, d5, and d6 based on a corresponding distance from the light emitter 410. Accordingly, even though a plurality of objects that are arranged in a row with the light emitter 410 may be in the same direction in view from the light emitter 410, the plurality of objects may be exposed to different patterns of IR lights.

An embodiment in which different patterns of IR lights reach with respect to different distances may employ refraction of light and interference. The embodiment may be configured by, for example, distance-based superpositioning IR lights, emitted from the light emitter 410 via a plurality of slits or holes, based on wavelength characteristics of the IR lights.

Referring to FIG. 4, an object 402 within a field of view 401 may be exposed to the pattern P6 among the various patterns P1, P2, P3, P4, P5, and P6 of IR lights emitted from the light emitter 410.

Accordingly, an angle θ2 may be determined based on the direction in which the pattern P6 is received. and an angle θ1 may also be determined since a distance d6 between the light emitter 410 and the object 402 exposed to the pattern P6 is specified.

In addition, like the embodiment of FIG. 3, since a distance, that is, a baseline ‘l’ between the light emitter 410 and a sensor 430 is known, a distance d between the sensor 330 and the object 402 may be calculated using a function of the angle θ1, the angle θ2, and the distance ‘l’. Here, d=f (θ1, θ2, l).

Without calculating the angle θ1, the distance d may be calculated using the function of the distance d6, the angle θ2, and the distance ‘l’. A detailed calculation process belongs to a basic triangulation scheme and thus, further detailed description will be omitted here.

According to the above scheme, the sensor 430 may generate a depth image by calculating a distance from each of patterns within the field of view 401.

FIG. 5 illustrates a configuration of an image generating apparatus 500 according to other example embodiments.

The image generating apparatus 500 may be an example of the image generating apparatus 100 according to the TOF scheme described above with reference to FIG. 1.

The image generating apparatus 500 may include a single reflector 520, which is different from the embodiment of FIG. 2. As described above with reference to FIG. 1, in the case of the TOF scheme, a distance between a light emitter 510 and a sensor 530 may need to be minimized in order to minimize a phase difference detection error. A plurality of light emitters 510 and 550 may be provided to increase IR intensity and complement a directivity error according to a position of a light emitter.

An IR light 511 that is modulated to have a predetermined wavelength and thereby is emitted from the light emitter 510 may reach an object 502 within a field of view 501 through the reflector 520.

A reflected IR light 512 that is reflected from the object 502 may be reflected again from the reflector 520 and reach the sensor 530. A processor 540 may be an example of the processor 140 of FIG. 1 and be an imaging processor that is connected to the sensor 530 to perform image processing.

An example in which the sensor 530 generates a depth image by receiving the reflected IR light 512 and by calculating a distance from the object 502 will be further described with reference to FIG. 6.

FIG. 6 illustrates a diagram to describe a process of generating a depth image based on a phase difference between an IR light emitted from a light emitter 610 and a reflected IR light reflected from an object 602 according to example embodiments.

The object 602 within a field of view 601 may reflect a predetermined wavelength of an IR light emitted from the light emitter 610, which is received at a sensor 630.

Accordingly, the IR light emitted from the light emitter 610 and the reflected IR light generated by reflecting the IR light from the object 602 may have the same wavelength and a phase difference θ.

The sensor 630 may calculate a distance between the sensor 630 and the object 602 using the phase difference θ. Since a position of the sensor 630 is different from a position of the light emitter 610, the distance calculated based on the phase difference θ may be greater than the distance between the sensor 630 and the object 602. However, the above error may be ignored by setting the distance between the sensor 630 and the light emitter 610 to be sufficiently smaller than the distance between the sensor 630 and the object 602. Depending on necessities, it may be possible to compensate for the error.

According to embodiments, a plurality of light emitters, for example, light emitters 610 and 620 of FIG. 6 may be provided to emit IR lights not having a phase difference and having the same wavelength. Therefore, it is possible to increase an IR intensity and to complement a directivity error according to a position of a light emitter.

The sensor 630 may generate a depth image by calculating a phase difference θ with respect to each of portions within the field of view 601.

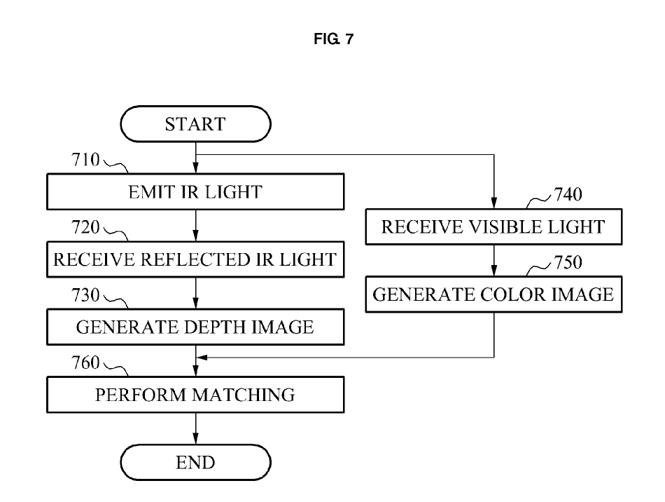

FIG. 7 illustrates an image generating method according to example embodiments.

In operation 710, the light emitter 110 of the image generating apparatus 100 may emit an IR light. The emitted IR light may be transferred to a field of view through the reflector 120.

As described above, a characteristic of the emitted IR light may be different depending on embodiments of a TOF scheme or a structured pattern light type scheme. Furthermore, in the structured pattern light type scheme, different embodiments may be employed for a pattern generating method.

In operation 720, the sensor 130 of the image generating apparatus 100 may receive a reflected IR light that is reflected from an object through the reflector 120. In operation 730, the sensor 130 may generate a depth image.

Various embodiments of operation 730 are described in detail with reference to FIG. 2 through FIG. 6.

The sensor 130 may receive a visible light in operation 740 and generate a color image in operation 750. In this example, the sensor 130 may be a depth and color sensor. This example is described above with reference to FIG. 1.

In operation 760, the processor 140 of the image processing apparatus 100 may match the depth image and the color image. A matching process and a preprocessing process prior to the matching process are described above with reference to FIG. 1.

The image generating method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image generating apparatus, comprising:
a light emitter to emit a first infrared light;
a reflector to reflect the first infrared light and thereby transfer the first reflected infrared light to an object, and to reflect a second reflected infrared light that is reflected from the object; and
a sensor to receive the second reflected infrared light that is reflected from the reflector, and to generate a depth image of the object.

2. The image generating apparatus of claim 1, wherein the reflector corresponds to an omni-directional mirror that simultaneously reflects, in predetermined directions, the first infrared light emitted from the light emitter.

3. The image generating apparatus of claim 1, wherein the sensor generates the depth image using a time of flight (TOF) scheme by detecting a phase difference between the first infrared light emitted from the light emitter and the second reflected infrared light that is reflected from the reflector.

4. The image generating apparatus of claim 1, wherein the sensor further generates a color image of the object by receiving visible light that is transferred from the object to the reflector and thereby is reflected from the reflector.

5. The image generating apparatus of claim 4, further comprising:
a processor to match the depth image and the color image by correcting at least one of a definition and a direction with respect to at least one of the depth image and the color image generated by the sensor.

6. The image generating apparatus of claim 5, wherein the processor performs at least one of preprocessing of noise cancellation and compensating of depth folding in the depth image before matching the depth image and the color image.

7. An image generating apparatus comprising:
a light emitter to emit a first infrared light;
a first reflector to reflect the first infrared light and transfer the first reflected infrared light to an object;
a second reflector to reflect a second reflected infrared light that is reflected from the object; and
a sensor to generate a depth image of the object by receiving the second reflected infrared light that is reflected from the second reflector.

8. The image generating apparatus of claim 7, wherein the first reflector corresponds to an omni-directional mirror that simultaneously reflects, in predetermined directions, the first infrared light emitted from the light emitter.

9. The image generating apparatus of claim 7, wherein the second reflector corresponds to an omni-directional mirror that reflects, towards the sensor, the second reflected infrared light reflected from the object present in a predetermined direction.

10. The image generating apparatus of claim 7, wherein the light emitter emits the first infrared light having a different pattern with respect to each of different angles.

11. The image generating apparatus of claim 10, wherein the sensor generates the depth image by determining a first angle between the light emitter and the object and a second angle between the sensor and the object based on a pattern of the reflected infrared light that is reflected from the second reflector, and by calculating a distance between the sensor and the object based on the first angle and the second angle.

12. The image generating apparatus of claim 7, wherein the light emitter emits the first infrared light so that different patterns are generated with respect to different distances.

13. The image generating apparatus of claim 12, wherein the sensor generates the depth image by identifying a reflected pattern corresponding to the object based on a pattern of the second reflected infrared light that is reflected from the second reflector.

14. The image generating apparatus of claim 7, wherein the sensor corresponds to a color and depth (C/D) sensor to further generate a color image of the object by receiving a visible light that is transferred from the object to the second reflector and is reflected from the second reflector.

15. The image generating apparatus of claim 14, further comprising:
a processor to match the depth image and the color image by correcting at least one of a definition and a direction with respect to at least one of the depth image and the color image generated by the sensor.

16. A method of generating a color image and a depth image in an image generating apparatus, the method comprising:
emitting, by a light emitter of the image generating apparatus, a first infrared light;
reflecting, by a first reflector of the image generating apparatus, the first infrared light to transfer the reflected infrared light to an object;
reflecting, by a second reflector of the image generating apparatus, a visible light and a second reflected infrared light that is reflected from the object, to a sensor of the image generating apparatus; and
receiving, by the sensor, the second reflected infrared light to generate the depth image, and receiving the visible light to generate the color image.

17. A non-transitory computer-readable recording medium storing computer readable instructions for instructing a computer to perform the method of claim 16.

18. A method of generating a color image and a depth image in an image generating apparatus, the method comprising:
emitting, by a light emitter of the image generating apparatus, an infrared light having different patterns corresponding to different directions of reflection;
reflecting, by a reflector of the image generating apparatus, a visible light that is reflected from an object and the reflected infrared light that is reflected from the object, to a sensor of the image generating apparatus; and
receiving, by the sensor, the reflected infrared light to generate the depth image, and receiving the visible light to generate the color image.

19. The image generating method of claim 18, wherein the reflector corresponds to an omni-directional mirror that simultaneously reflects, into predetermined directions, the infrared light emitted from the light emitter and reflects, towards the sensor, the reflected infrared light reflected from the object present in a predetermined direction.
